(19) United States
(12) Patent Application Publication
(10) Pub. No.: US 2021/0049593 A1
(43) Pub. Date: Feb. 18, 2021

(54) Digital Pharmacy Discount and Loadable Payment Card and Systems and Methods for Use of Such Card

(71) Applicant: RxGiftCard, LLC, Austin, TX (US)

(72) Inventors: Trevor Smith, Austin, TX (US); Del Kolbe, Austin, TX (US)

(73) Assignee: RxGiftCard, LLC, Austin, TX (US)

(21) Appl. No.: 16/991,571

(22) Filed: Aug. 12, 2020

Related U.S. Application Data
(60) Provisional application No. 62/885,920, filed on Aug. 13, 2019.

(51) Int. Cl. G06Q 20/38; G06Q 20/34; G06Q 20/26

(52) U.S. Cl. CPC G06Q 20/387; G06Q 20/26; G06Q 20/351

(57) ABSTRACT

A digital card, “DPD&P card,” functions as both (a) a prescription drug discount card and (b) a loadable/reloadable stored-value account card (e.g., debit card) for purchasing prescription drugs. A client displays the DPD&P card at a mobile device (e.g., smartphone), including drug discount identification information, which is read at a pharmacy point-of-sale (POS) and forwarded to a pharmacy benefits manager (PBM) to identify a discount for a drug purchase. The client may initiate, via the mobile device, a request to redeem funds onto the DPD&P card, and in response, a financial entity generates or updates a debit account balance linked to the DPD&P card. During a drug purchase transaction, a debit account identifier (e.g., barcode) linked to the debit account balance is displayed at the client mobile device, and read at a pharmacy POS to access the debit account balance to make a full or partial payment for the drugs.

### RELATED APPLICATION

This application claims priority to commonly owned U.S. Provisional Patent Application No. 62/885,920 filed Aug. 13, 2019, the entire contents of which are hereby incorporated by reference for all purposes.

### TECHNICAL FIELD

The present disclosure relates to a digital pharmacy discount and reloadable payment card, and systems and methods for using such card.

### BACKGROUND

A pharmacy discount card, also called a pharmacy savings card, prescription discount card or prescription drug savings card, is a physical or digital card that a customer (also referred to herein as a client) can present at a participating pharmacy to receive a discount on prescriptions for the customer. When the customer initiates a medication purchase at the pharmacy point-of-sale (POS), the customer presents the pharmacy discount card and the pharmacy POS collects identification information from the card. For example, the pharmacist may read identification information printed on the discount card and manually enter the information at a POS terminal, or identification information stored on the discount card (e.g., in an embedded magnetic strip or microchip) may be automatically read by an automated card reader or scanning device. The pharmacy POS may then forward the identification information to a Pharmacy Benefits Manager (PBM) having pre-negotiated drug pricing with the relevant pharmacy, which typically defines customer-specific discounts. The PBM identifies the negotiated discounted price for the particular customer and communicates the discounted drug price to the pharmacy POS, which in turn communicates the price to the customer. The customer may then complete the purchase transaction using any suitable form of payment, e.g., credit card, debit card, mobile payment (also called mobile money or mobile wallet), check, or cash.

FIG. 1 shows an example of a conventional pharmacy discount card 100. The example pharmacy discount card 100 lists various identification information 102, including (a) an Authorization number, (b) a prescription Banking Identification Number (BIN or Rx BIN), which indicates which company will reimburse the pharmacy for the cost of the prescription, (c) a GROUP number, which identifies a group insurance plan provided by a particular insurance provider, and (d) a Processor Control Number (PCN), typically used to route pharmacy claim transactions for health insurers. A pharmacy discount card may also include a Member ID, an identifier specific to the cardholder.

FIG. 2 shows a general representation of the pharmacy infrastructure in the United States, in particular showing the pharmacy and distribution system for patient-administered outpatient brand-named drugs. The diagram illustrates the product flow and financial flow through the system, along with the contractual relationships between various entities in the system. In a conventional scenario, the patient may use a pharmacy discount card at the pharmacy, which may interact with a pharmacy benefits manager (PBM) to provide a patient-specific discount, as discussed above.

### SUMMARY

Embodiments of the present invention provide a digital pharmacy discount card that also provides a stored-value money account, e.g., similar to a gift card or debit card, wherein the stored-value money account (e.g., debit account) may be loadable and/or reloadable by the cardholder or others. Thus, in some embodiments, a digital card may combine some or all aspects of a digital pharmacy discount card with a stored-value money card, often referred to as a gift-card. These cards are referred to herein as “digital pharmacy discount and payment cards” or “DPD&P” cards.

One aspect provides a system for managing a digital card usable by a client for receiving discounts on drugs purchased from a pharmacy and also usable for payment of drug purchases. The system may include non-transitory computer-readable media storing computer instructions for managing and using the digital card, and at least one processor configured to execute the computer instructions to:
display, at a client mobile device, a representation of the digital card, including prescription drug discount identification information associated with the digital card, the prescription drug discount identification usable for receiving discounts on drugs purchased from the pharmacy;
display, at a client mobile device, a card balance associated with the digital card;
receive, at the client mobile device, a funds redemption request to redeem a first amount representing at least a portion of the card balance;
forward the funds redemption request to a financial entity for generating or updating a debit account balance linked to the digital card as a function of the first amount; and
during a drug purchase transaction for at least one drug:
   send a discount request to a pharmacy benefits manager computer system, the discount request including (a) the prescription drug discount identification information associated with the digital card and (b) an identification of the at least one drug;
   receive a discount request response from the pharmacy benefits manager computer system, the discount request response identifying a discounted price for the at least one drug determined based at least on the forwarded prescription drug discount identification information; and
   display at the client mobile device a debit account identifier linked to the debit account balance, the debit account identifier being readable at a pharmacy point-of-sale system for accessing the debit account balance to make a full or partial payment for the at least one drug.

In some embodiments or instances, the funds redemption request is received and forwarded to the financial entity during the drug purchase transaction for the at least one drug. For example, the funds redemption request may be received and forwarded to the financial entity after the discount request discount request response is received from the pharmacy benefits manager computer system. In some embodiments or instances, the funds redemption request is received and forwarded to the financial entity prior to the start of the drug purchase transaction.

In some embodiments, receiving the funds redemption request at the client mobile device comprises receiving input from the client, at the client mobile device, indicating the first amount to be redeemed.

In some embodiments, the at least one processor is further configured to display at the client mobile device, after the drug purchase, an updated card balance for the digital card, the updated card balance being updated based on the full or partial payment for the at least one drug made using the debit account balance.

In some embodiments, the at least one processor is further configured to receive from the financial entity, in response to the forwarded funds redemption request, the debit account identifier or a corresponding debit account number linked to the debit account balance.

In some embodiments, displaying the debit account identifier at the client mobile device comprises displaying a barcode or other scannable representation of a debit account identification number.

Another aspect provides a method for managing a digital card usable by a client for receiving discounts on drugs purchased from a pharmacy and also usable for payment of drug purchases. The method may include:
displaying, at a client mobile device, a representation of the digital card, including prescription drug discount identification information associated with the digital card, the prescription drug discount identification usable for receiving discounts on drugs purchased from the pharmacy;
displaying, at a client mobile device, a card balance associated with the digital card;
receiving, at the client mobile device, a funds redemption request to redeem a first amount representing at least a portion of the card balance;
forwarding the funds redemption request to a financial entity for generating or updating a debit account balance linked to the digital card as a function of the first amount; and
during a drug purchase transaction for at least one drug:
   sending a discount request to a pharmacy benefits manager computer system, the discount request including (a) the prescription drug discount identification information associated with the digital card and (b) an identification of the at least one drug;
   receiving a discount request response from the pharmacy benefits manager computer system, the discount request response identifying a discounted price for the at least one drug determined based at least on the forwarded prescription drug discount identification information; and
   displaying at the client mobile device a debit account identifier linked to the debit account balance, the debit account identifier being readable at a pharmacy point-of-sale system for accessing the debit account balance to make a full or partial payment for the at least one drug

In some embodiments, the steps of sending the discount request and receiving the discount request response are performed by a pharmacy point-of-sale processor.

In some embodiments, the steps of receiving and forwarding the funds redemption request to the financial entity for generating or updating the debit account balance are performed during the drug purchase transaction. For example, the steps of receiving and forwarding the funds redemption request may be performed after the discount request response is received from the pharmacy benefits manager computer system.

In other some embodiments, the steps of receiving and forwarding the funds redemption request to the financial entity for generating or updating the debit account balance are performed prior to the drug purchase transaction.

In some embodiments, receiving the funds redemption request at the client mobile device comprises receiving input from the client, at the client mobile device, indicating the first amount to be redeemed.

In some embodiments, the method further includes, after the drug purchase, displaying at the client mobile device an updated card balance for the digital card, the updated card balance being updated based on the full or partial payment for the at least one drug made using the debit account balance.

In some embodiments, the method further includes receiving from the financial entity, in response to the forwarded funds redemption request, the debit account identifier or a corresponding debit account number linked to the debit account balance.

In some embodiments, displaying the debit account identifier at the client mobile device comprises displaying a barcode or other scannable representation of a debit account identification number.

Another aspect provides a system for processing a prescription drug purchase by a client using a digital card displayable on a client mobile device, the digital card including (a) prescription drug discount identification information for receiving discounts on prescription drugs and (b) an account balance associated with the digital card. The system may include non-transitory computer-readable media storing computer instructions for processing a prescription drug purchase using the displayable digital card, and at least one processor associated with a pharmacy point-of-sale (POS) system and configured to execute the computer instructions to:
during a drug purchase transaction for at least one drug, collect the prescription drug discount identification information associated with the digital card and displayed on the client mobile device;
send, to a computer system of a pharmacy benefits manager, a discount request including (a) the collected prescription drug discount identification information associated with the digital card and (b) an identification of the at least one drug
receive, from the computer system of the pharmacy benefits manager, a discount request response identifying a discounted drug price for the at least one drug;
collect account identification information read from the client mobile device;
send, to a computer system of a financial system, the collected account identification information;
receive, from the computer system of the financial system, a debit account balance associated with the collected account identification information; and
complete the transaction to purchase the particular drugs by the client, based at least on account balance received from the financial system.

In some embodiments, collecting account identification information read from the client mobile device comprises scanning a bar code or other scannable account identifier displayed on the client mobile device.

### BRIEF DESCRIPTION OF THE DRAWINGS

Example aspects of the present disclosure are described below in conjunction with the figures, in which:

FIG. 1 shows an example of a conventional pharmacy discount card.

FIG. 2 shows a general representation of the pharmacy infrastructure in the United States, showing the pharmacy and distribution system for patient-administered outpatient brand-named drugs.

FIG. 3 shows various system components of an example digital pharmacy discount and payment card (DPD&P) system, according to embodiments of the present invention.

FIGS. 4A-4J illustrate a series of screen shots (e.g., representing web pages or application screens) generated by a DPD&P client application and displayed on a client device, according to one example embodiment.

FIG. 5 illustrates an example process of a client (DPD&P cardholder) completing a drug purchase transaction using the example DPD&P system shown in FIG. 3, wherein the client's DPD&P card has available funds (redeemed funds) prior to the transaction, according to one example embodiment.

FIG. 6 illustrates an example process of a client (DPD&P cardholder) completing a drug purchase transaction using the example DPD&P system shown in FIG. 3, in which the client redeems funds onto the DPD&P card during the purchase transaction, which redeemed funds are then used for the drug purchase, according to one example embodiment.

FIG. 7 is a flowchart providing an another representation of the example process shown in FIG. 6, according to one example embodiment.

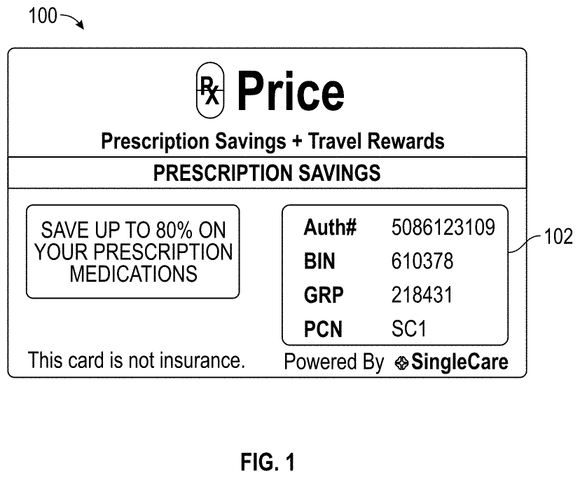

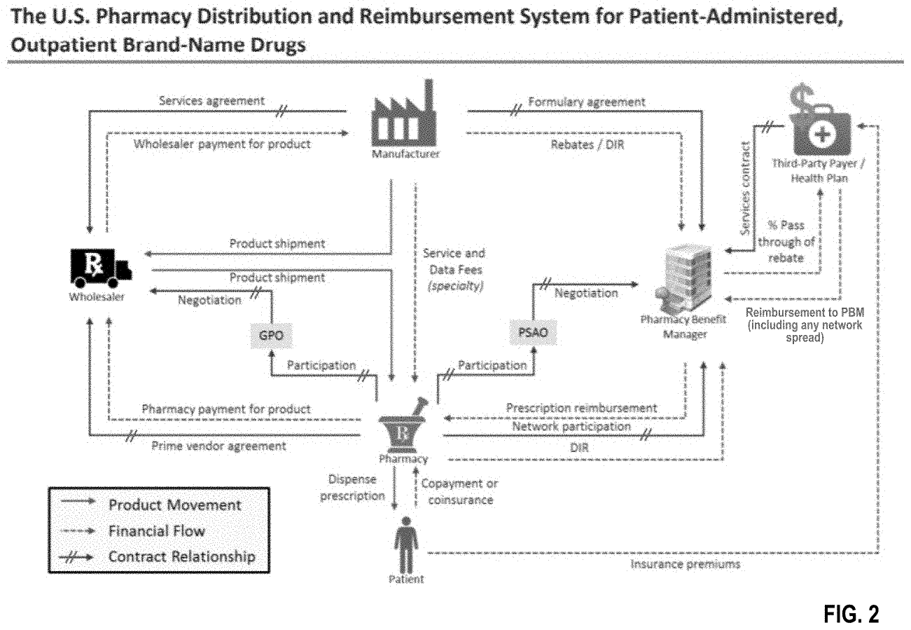

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

As discussed above, some embodiments of the present invention provide a digital pharmacy discount and payment cards. or “DPD&P” cards that act as both a pharmacy discount card and a reloadable digital gift-card, e.g., redeemably at one or more specified pharmacy (or other specified vendor(s)) for prescription or health care products. In some embodiments, a cardholder or DPD&P card provider may select a particular pharmacy at which to redeem the card. The card may then be converted to a specific pharmacy brand, e.g., Walmart, Costco, CVS, etc.

In some embodiments, DPD&P cards may be sold to consumers, provided by corporations or other employers as compensation or gifts, and/or otherwise distributed to end users, referred to herein as cardholders or clients. For example, a system providing DPD&P cards may provide a platform to provide financial assistance to family and friends. As another example, a corporation may provide DPD&P cards to help reduce the cost of prescriptions for their employees. As another example, drug manufacturers may use DPD&P cards to offer additional incentives to consumers, e.g., in the growing market of specialty drugs.

DPD&P cards may be delivered and accessible to clients via any suitable computer system or protocol. For example, digital pharmacy discount and payment cards may be delivered and accessible to clients via web-based interface and/or via an application stored on or otherwise accessible via a mobile device (e.g., smartphone). Some embodiments provide a ubiquitous mobile device application with a universal e-wallet for clients.

Some embodiments provide systems and methods for generating, using, and managing DPD&P cards. Such systems may be referred to herein as DPD&P systems. In some embodiments, a DPD&P system may include any combination of the following:
(a) interface(s) for generating, accessing and interfacing with DPD&P cards, e.g., web-based interfaces or mobile device application,
(b) a back-end system for managing DPD&P cards,
(c) pharmacy point-of-sale (POS) computer system(s) configured to interact with DPD&P cards during purchases of prescription drugs by clients, e.g., by scanning, reading, or otherwise collecting pharmacy discount data and payment account information from DPD&P cards, and/or
(d) financial system computer system(s) associated with the pharmacy POS computer system(s).

In some embodiments, a DPD&P system may utilize a secure blockchain hyper ledger service, e.g., to track card ownership and all transactions executed by the DPD&P system.

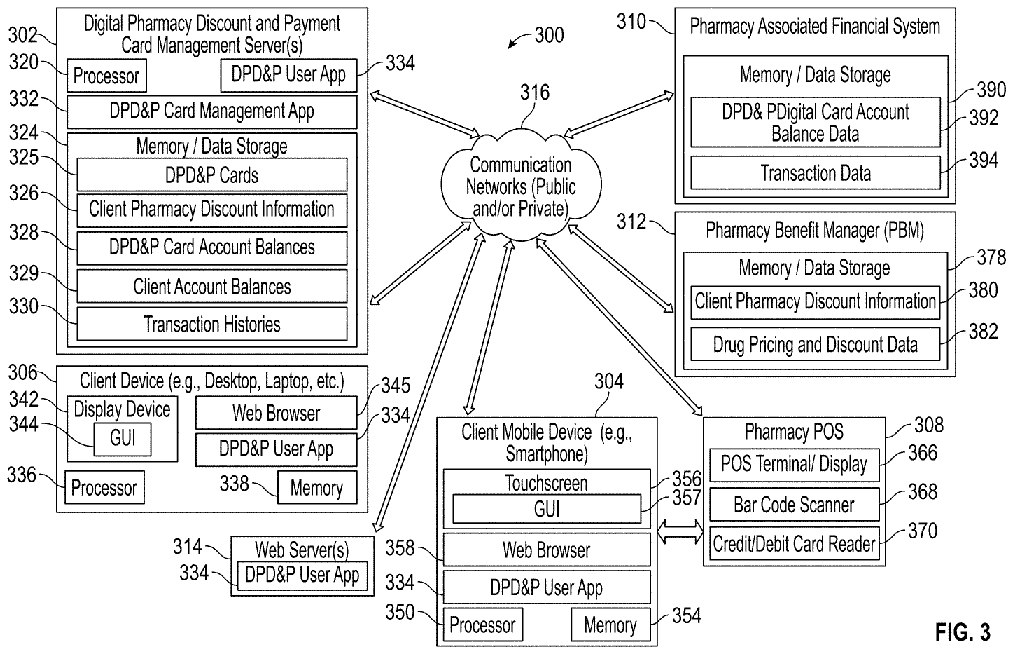

FIG. 3 shows various system components of an example DPD&P system 300, according to embodiments of the present invention. The example DPD&P system may include one or more digital pharmacy discount and payment (DPD&P) management server 302, client mobile device 304 (e.g., smartphones, tablet, smartwatches, etc.), other client device 304 (e.g., desktop PCs, laptops, etc.), pharmacy point-of-sale (POS) system 308, pharmacy-associated financial system 310 associated with each pharmacy POS system 308, pharmacy benefit manager (PBM) 312, web server 314, and communication network 316, e.g., the internet, private network(s), LAN(s), WLAN(s), and/or any other type(s) of network(s).

System 300 may include any number of instances of each system component 302-312, e.g., covering any number of users, pharmacy locations and/or pharmacy brands, associated financial systems, and PBMs. Each component 302-312 may include any hardware, software, and communications devices for providing the functionality of the DPD&P system 300. For example, each system component may include one or more processors configured to execute software, firmware and/or other executable logic to provide the respective functionality of the respective system component, memory/data storage devices for storing such software, firmware and/or other executable logic and/or data or other information relevant to the operation of the respective system component, input devices for receiving input (e.g., manually entered or automatically collected input), and display devices or other output device (e.g., speakers) for visual, audible, etc. output of information.

DPD&P management server(s) 302 may be configured to manage the creation and use of DPD&P cards, along with client accounts associated with DPD&P cards, including for example the management of client identification information and account balance information (e.g., client account balances, specific card balances, and redeemed funds balances). As shown, each DPD&P management server 302 may include a processor 320, memory/data storage device(s) 324, and/or any other suitable components for performing any of the functionality disclosed herein. Memory/data storage device(s) 324 may store software and various data related to the operation of DPD&P system 300, for example, DPD&P card data 325, client pharmacy discount information 326, DPD&P cards account balance data 328, client account balance data 329, and transaction hi story data 330.

DPD&P management server(s) 302 may include a DPD&P management application 332 (e.g., embodied as software) executable to manage the creation and use of DPD&P cards 325, along with any of the various information stored in memory 324. DPD&P management server(s) 302 may also provide a digital interface for a client to access her DPD&P card(s) 325 and associated information using a DPD&P client application 334 provided at a client device 304 or 306, as discussed below. As discussed below, DPD&P client application 334 may be embodied as (a) a web-based application allowing access to DPD&P management server 302 via a web browser at a client device 304 or 306, or (b) a downloadable application (e.g., mobile app) fully or partially loaded onto a client device 304 or 306.

In some embodiments or implementations, DPD&P client application 334 and DPD&P management application 332 comprise modules, services, APIs, or other software components integrated in a common software product. For example, in some embodiments, DPD&P client application 334 and DPD&P management application 332 comprise functional components of a common software application or product hosted at a DPD&P management server 302, which may provide web-based access, e.g., via a web browser 358, 345 at a client device 304 or 306, to some or all features of the integrated application. In other embodiments or implementations, DPD&P client application 334 and DPD&P management application 332 may be embodied as fully or partially separate software products configured to cooperatively interact with each other. For example, DPD&P management application 332 may be hosted at a DPD&P management servers 302, while DPD&P user application 332 may be a downloadable application loaded on a client device 304 or 306 or a web-based application hosted at a web server 314 and accessible to a client via a web browser 358, 345 at a client device 304 or 306. DPD&P client application 334 and DPD&P management application 332 may be configured to cooperatively interact with each other to perform the various functionality described herein. For example, DPD&P management application 332 may be configured to dynamically update and maintain account balance information 328 and 329 based on user selections received via a DPD&P client application 334, and subsequently access and deliver such account balance information 328 and 329 when called via DPD&P client application 334, e.g., for display at a client device GUI.

Each client mobile device 304 may include a processor 350, memory/data storage device(s) 354, and a plurality of user device input/output devices (“I/O devices”), including for example a display device 356 (e.g., LED touchscreen) that provides a graphical user interface (GUI) 357, a web browser 358, a microphone, speaker, and camera. Client mobile device 304 provides a DPD&P client application 334, configured to engage with the client (end user) via touchscreen 356 and/or other I/O devices of client mobile device 304. DPD&P client application 334 may display information to the client and receive input from the client via GUI 357. Memory/data storage device(s) 354 may store software and various data related to the operation of DPD&P system 300.

DPD&P client application 334 may include, for example, a program file or collection or suite of program and data files in any suitable language or format (e.g., JavaScript, JSON, etc.) which may be stored or hosted at any suitable device or devices in system 300, e.g., hosted at a single device or between multiple devices. As noted above, DPD&P client application 334 may be embodied as a web-based application or a downloadable application (e.g., mobile app). As used herein, reference to client mobile device 304 “providing” DPD&P client application 334 means client mobile device 304 provides a client access to DPD&P client application 334, which may include, for example, (a) client mobile device 304 storing or hosting all or a portion of a DPD&P client application 334 in local memory 12, e.g., where a client downloads a DPD&P client application 334, for example via an iPhone or Android “app store,” or (b) web browser 358 providing the client access to a remotely stored web-based DPD&P client application 334, e.g., stored at a DPD&P management server 302 or other web servers 314, via network 316.

System 300 may include other client device(s) 306, e.g., one or more desktop or laptop computer, e.g., to provide another client interface for managing PDP&D cards 325 and related accounts. Each such client device 306 may include a processor 336, memory/data storage device(s) 338, and a plurality of user device input/output devices (“I/O devices”), including for example a display device 342 (e.g., touchscreen or monitor) that provides a graphical user interface (GUI) 344, a web browser 345. Like the client mobile device 304 discussed above, a client device 306 may also provide DPD&P client application 334, e.g., in the form of a locally downloaded application or access to a remote web-based application via browser 345, wherein the client may interface with the DPD&P application 334 via GUI 344 provided at display device 342. Memory/data storage device(s) 338 may store software and various data related to the operation of DPD&P system 300.

Each pharmacy POS system 308 may include a POS terminal including at least one display 366, a bar code scanner 368, a card reader 370 (e.g., for reading credit cards, debit cards, gift cards, etc.), and other suitable components for interfacing with DPD&P cards 325 and completing drug purchase transactions using DPD&P cards 325. In some embodiments, a pharmacy POS system 308 does not require the additional of any hardware for interfacing with DPD&P cards 325, e.g., for completing drug purchase transactions using DPD&P cards 325.

A pharmacy-associated financial system 310 may include a bank or other financial entity associated with one or more pharmacy POS system 308. In some embodiments, a pharmacy-associated financial system 310 may be configured to generate, update, and maintain DPD&P card account balance(s) for each DPD&P card 325, e.g., in response to client requests to redeem funds and in response to completed drug purchase transactions using DPD&P cards 325. Thus, as shown, pharmacy-associated financial system 310 may include memory/data storage device(s) 390 storing DPD&P account balance data 392 and DPD&P card-related transaction data 394 for any number of DPD&P cards 325 held by any number of clients. The pharmacy-associated financial system 310 may provide account balance data to DPD&P management server(s) 302 (e.g., upon request), such that the DPD&P management server(s) 302 may update DPD&P card account balances 328 and client account balances 329 maintained on such server(s) 302.

Finally, a pharmacy benefit manager (PBM) 312 may include memory/data storage device(s) 378 storing client pharmacy discount information 380 and drug pricing and discount data 382.

The various system components 302-312 of DPD&P system 300 may be communicatively connected to each other by one or more network 316, which may include, for example, the internet, one or more local area network (LAN), wide area network (WAN), mobile networks (e.g., GSM), or any other type of public or private network including wired and/or wireless communication links.

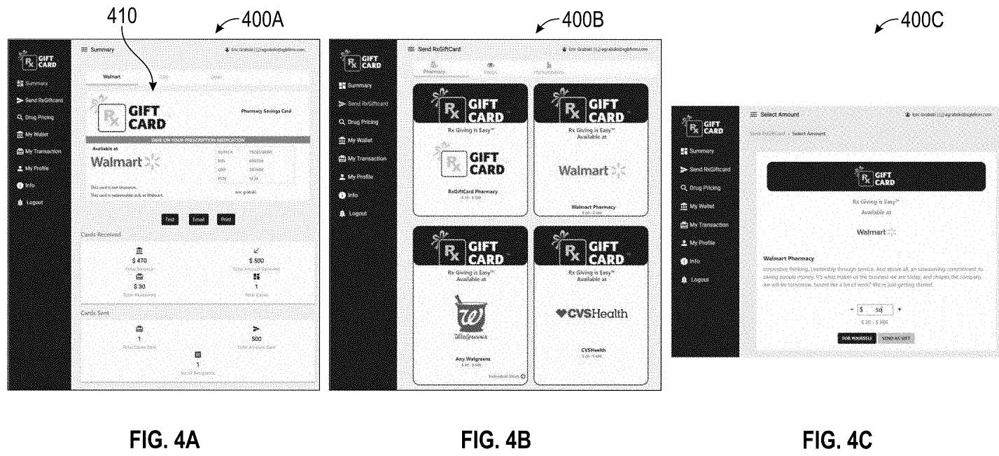

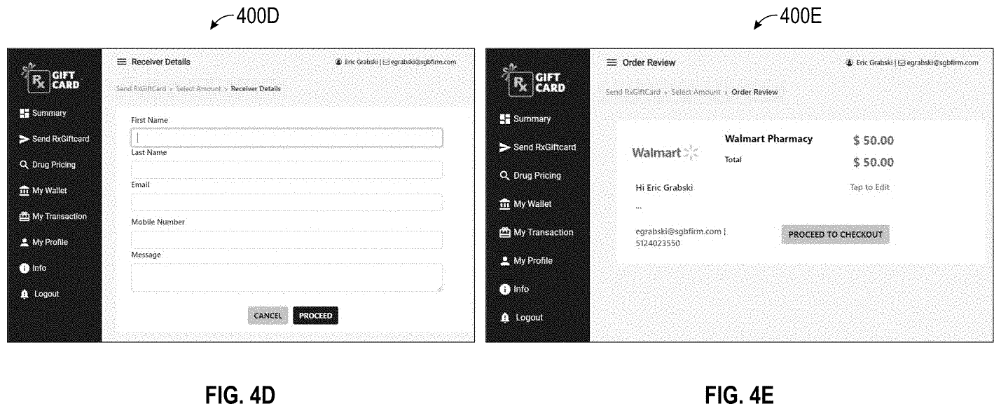

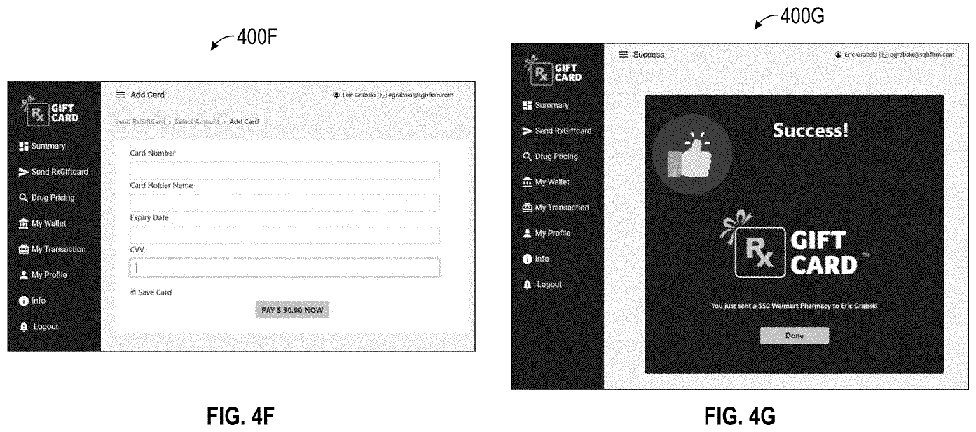

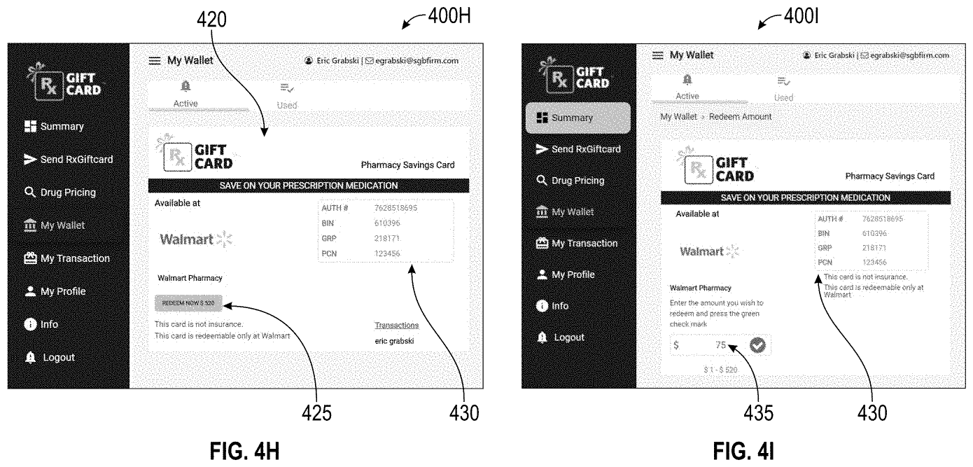

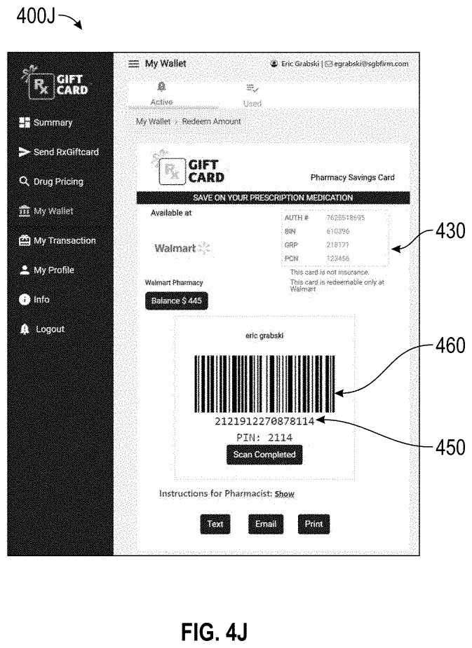

FIGS. 4A-4J illustrate a series of screen shots (e.g., representing web pages or application screens) generated by a DPD&P client application 334 and displayed on a client device 304 or 306, according to one example embodiment.

FIG. 4A shows a “Summary” screen 400A summarizing a DPD&P digital wallet (e-wallet) for a particular client, showing:
two selectable DPD&P cards for the client: a Walmart brand DPD&P card 410 (generated), and a CVS brand DPD&P card (not generated);
the selected Walmart brand DPD&P card 410, showing the authorization number (AUTH #), BIN, GRP, and PCN for the client;
a summary of information for DPD&P cards received by the client, including current total balance ($470), total redeemed funds ($30), and a historical total amount of received funds ($500); and
a summary of cards sent by the client, either to the client him/herself or to another person.

FIG. 4B shows a selected “Send RxGiftCard” screen 400A, allowing the client to send/fund a DPD&P card for a selected pharmacy brand to themselves or to another client.

FIG. 4C shows a screen 400C displayed after the client selects to send a Walmart branded DPD&P card, which allows the client to select an amount ($50) to send for the DPD&P card.

FIG. 4D shows a displayed screen 400D allowing the client to input identification information for the recipient of the $50 Walmart DPD&P card. In this example, the client sends the $50 to himself, which will increase the client's existing Walmart DPD&P card balance from $470 to $520.

FIG. 4E shows a displayed screen 400E allowing the client to review the order to send the $50 Walmart DPD&P card.

FIG. 4F shows a displayed screen 400F allowing the client to enter payment information for funding the $50 Walmart DPD&P card.

FIG. 4G shows a displayed “Success” screen 400G indicating the $50 Walmart DPD&P was sent.

FIG. 4H shows a displayed “My Wallet” screen 400H showing the Walmart DPD&P card 420, including (a) the client's pharmacy discount card ID information 430, in this example Auth #, BIN, GRP, and PCN numbers, and (b) the current redeemable balance, which is $520. The “Summary” screen (not shown here) is also updated to indicate the new total balance of $520.

The total balance of $520 represents funds that are available to the client to be “redeemed” for use via the Walmart DPD&P card 420. The client may initiate a redemption request by selecting a “Redeem Now” button 425. In this example embodiment, to redeem funds, the client requests an amount to redeem (“requested redemption amount”), and this request is forwarded to a pharmacy-associated financial system 310, in this example a bank or financial system associated with the Walmart pharmacy. The client may initiate the redemption request using the DPD&P client application 334, and the DPD&P management server 302 may communicate the redemption request to the Walmart pharmacy associated bank 310. FIG. 4I shows a displayed screen 400I in which the client requests to redeem $75 of the available $520 balance.

The Walmart pharmacy associated bank 310 may receive the redemption request and generate a debit account linked to the client's DPD&P card, for the requested redemption amount. Alternatively, if the client's DPD&P already has an existing DPD&P debit account with a redeemed balance, the bank 310 may add the requested redemption amount to the existing redeemed amount of the client's DPD&P debit account. The Walmart pharmacy associated bank 310 may then send DPD&P debit account information, e.g., a debit account number and debit account balance, to DPD&P management server 302, which may then display related information to the client via the GUI 357 at the client's mobile device (e.g., smartphone) 304.

For example, the DPD&P management server 302 may display a scannable bar code representing the client's DPD&P debit account number, and in some embodiments a PIN, which may be generated by the bank or selected by the user, depending on the particular embodiment. FIG. 4J shows a displayed screen 400J showing an example DPD&P debit account number 450 and scannable bar code 450 representing the debit account number 450.

In some embodiments or situations, a client may submit a redemption request before or during a transaction for purchasing prescription drugs at a relevant pharmacy POS (in this example, a Walmart pharmacy). During a drug purchase transaction, the client may present the DPD&P card to the pharmacist, who may read or enter into a pharmacy POS terminal 308 the pharmacy discount identification information listed on the DPD&P card, e.g., BIN, PCN, GROUP, and (optionally) Authentication number. The pharmacist may also enter into the pharmacy POS terminal 308 a list of drugs to be purchased. The pharmacy POS terminal 308 may then send the client's pharmacy discount identification information and the list of drugs to a relevant PBM 312, which may determine and return a discounted drug cost to the pharmacy POS terminal 308, and the pharmacy POS terminal 308 or the pharmacist may then relay the cost information to the client. The PBM 312 may determine the discounted drug cost based on stored pharmacy discount information 380 for the Walmart pharmacy and/or drug pricing and discount data 382 corresponding with the client's pharmacy discount identification information.

The client may then elect to pay all or a portion of the amount due using the redeemed funds linked to the DPD&P debit account represented by the bar code 450 displayed on the DPD&P card. The pharmacist may then scan the debit account bar code 450 using a bar code scanner 368, and the pharmacy POS terminal 308 may forward the associated debit account number to the pharmacy-associated bank 310, which may identify and return the DPD&P card account balance 392 to the pharmacy POS terminal 308. The pharmacist may then complete the transaction, e.g., using only the DPD&P card debit account, or using a combination of the DPD&P debit account and additional funds provided via conventional means (e.g., credit card, bank debit card, check, or cash). The pharmacy POS terminal 308 may then notify the pharmacy-associated bank 310 of the amount of funds used from the DPD&P debit account, and the bank 310 may update the DPD&P card account balance information 392, and also cooperate with DPD&P management server 302 to update the account balance data 328 stored at server 302.

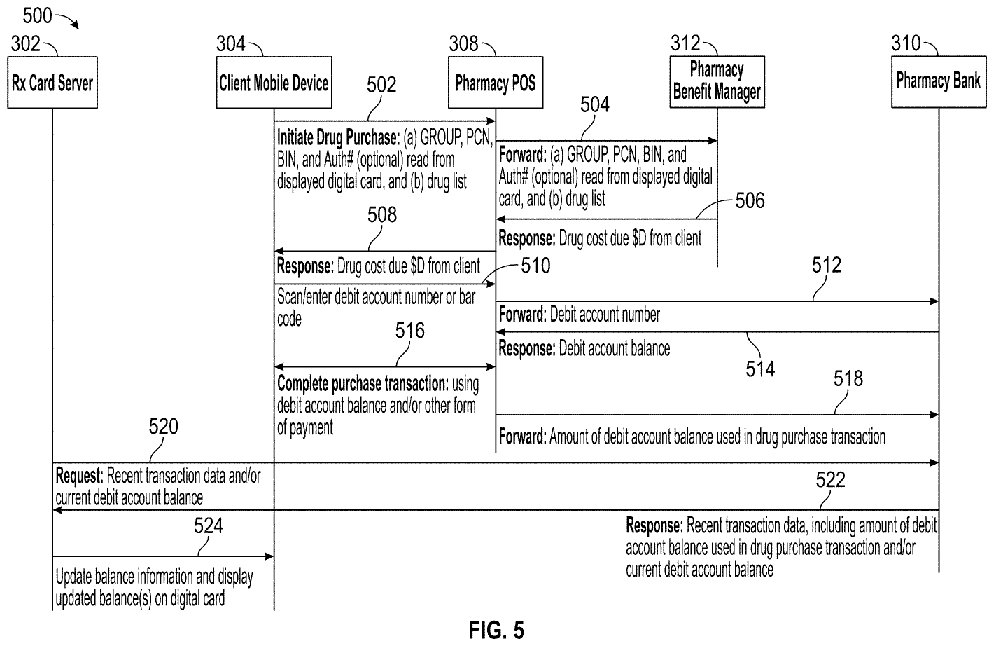

FIG. 5 illustrates an example process 500 for a client (DPD&P cardholder) to complete a drug purchase transaction using the example DPD&P system 300 shown in FIG. 3, using a DPD&P card 325 having available funds (e.g., redeemed funds) prior to the beginning of the transaction, according to one example embodiment. At 502, the client may initiate a drug purchase at a pharmacy POS system 308, e.g., by providing the pharmacist (a) the client's pharmacy discount identification information and (b) an identification of a drug or drugs to be purchased. To provide the pharmacist the client's pharmacy discount identification information, the client may open DPD&P client application 334 at a smartphone or other mobile device 304 and navigate to a page displaying a selected DPD&P card showing the DPD&P card ID information, e.g., any of the “My Wallet” screens shown in FIG. 4H, 4I, or 4J, which displays at mobile device GUI 357 a selected DPD&P card including pharmacy discount card ID information 430, in this example Auth #, BIN, GRP, and PCN numbers. The pharmacist may read the displayed DPD&P card ID information 430 and enter (e.g., via manual keyboard entry) this information, along with the requested drug(s), into a pharmacy POS terminal 366 using any suitable data entry interface.

At 504, the pharmacy POS system 308 (e.g., POS terminal 366 in particular) may send a discount request to a relevant PBM 312, including the information entered at 502, including the DPD&P card ID information 430 and an identification of the requested drug(s). At 506, the PBM 312 may determine and return a discount request response to the pharmacy POS terminal 308, indicating a discounted drug cost determined by PBM 312, e.g., based on stored pharmacy discount information 380 for particular the Walmart pharmacy and/or drug pricing and discount data 382 corresponding with the client's pharmacy discount identification information.

At 508, the pharmacy POS terminal 308, or the pharmacist viewing terminal 308, may then relay the cost information received from PBM 312 to the client. To make payment of the amount determined by PBM 312, at 510 the pharmacist may enter the DPD&P card debit account number displayed on the mobile device GUI 357 (e.g., in the form of a displayed number 450 or barcode 460 representing the debit account number) into the POS terminal 366, e.g., by typing in the debit account number 450 or scanning the barcode 460 using a bar code scanner 368. At 512, the POS terminal 366 may then forward the DPD&P card debit account number to a pharmacy-associated bank 310. At 514, the bank 310 may then identify the relevant account balance 392 corresponding with the DPD&P card debit account number, and communicate the account balance information 392 to the POS terminal 366, or at least an indication of whether the account balance is sufficient to cover the cost of the drugs. In some embodiments or instances, the POS terminal 366 may display such account balance information to the client, or the pharmacist may relay such information displayed at the POS terminal 366 to the client.

At 516, the client may then interact with the pharmacist and pharmacist POS terminal 36 to compete the purchase transaction using some or all of the DPD&P card debit account balance and/or another form of payment (e.g., credit card, debit card, cash, check, etc.). For example, the client may then determine and indicate to the pharmacist the amount (if any) of the DPD&P card debit account balance to apply to the drug purchase, and the pharmacist may enter such value at the POS terminal 366. If the elected (or available) DPD&P card debit account balance is less than the total cost of the drugs, the client may pay the remainder using any other form of payment, e.g., using a credit/debit card reader 370 at the pharmacy POS system 308.

At 518, the amount of the DPD&P card debit account balance applied to the drug purchase, as entered into the POS terminal 366 at 516, is forwarded to the pharmacy-associated bank 310, which may then update the DPD&P card account balance information 392 accordingly.

The pharmacy-associated bank 310 may then (or at some later time) notify DPD&P management application 332 at the relevant DPD&P management server 302 of the drug purchase transaction and the updated DPD&P card account balance information 392, such that DPD&P management application 332 at may update the records in DPD&P management server memory 324. In the embodiment shown in FIG. 5, at 520, DPD&P management application 332 may periodically request, e.g., at a specified frequency or in response to a defined triggering event, recent transaction data and DPD&P card account balance updates from the pharmacy-associated bank 310. Server 302 may request data regarding the particular DPD&P card debit account, or data regarding all DPD&P card debit accounts managed by bank 310. At 522, bank 310 may access and forward the requested information to DPD&P management application 332 at DPD&P management server 302. In an alternative embodiment, rather than awaiting update requests from DPD&P management application 332 (step 520), the pharmacy-associated bank 310 may automatically send DPD&P management application 332 the transaction data and updated DPD&P card account balance information upon completion of each purchase transaction involving bank 310.

At 524, DPD&P management application 332 may update the records in DPD&P management server memory 324, e.g., DPD&P card debit account balance information 328 and transaction history data 330, based on the information received from bank 310, and DPD&P client application may then access display at the mobile device GUI 357 the updated DPD&P card debit account balance.

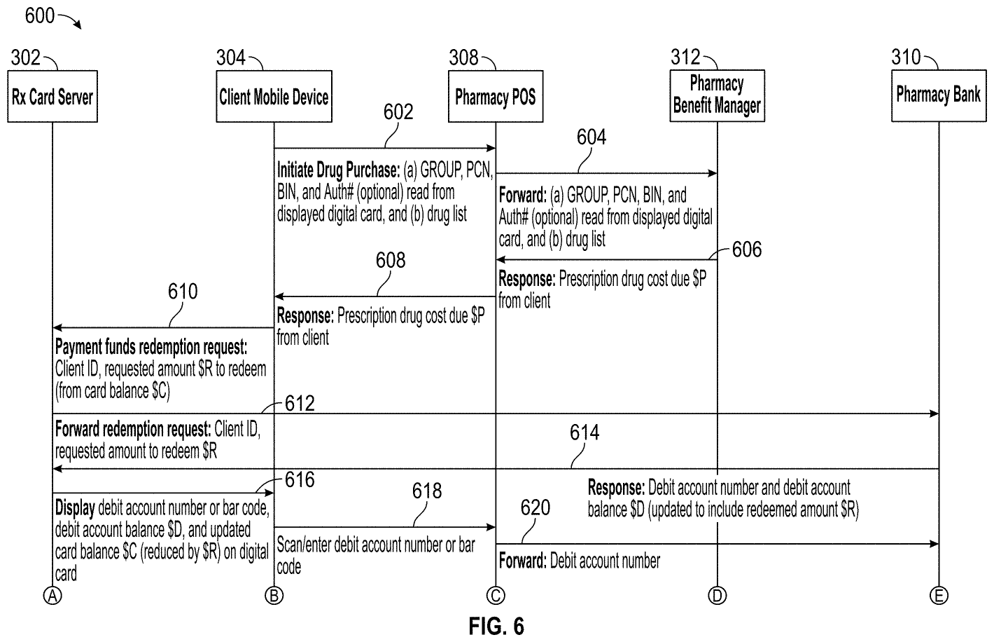

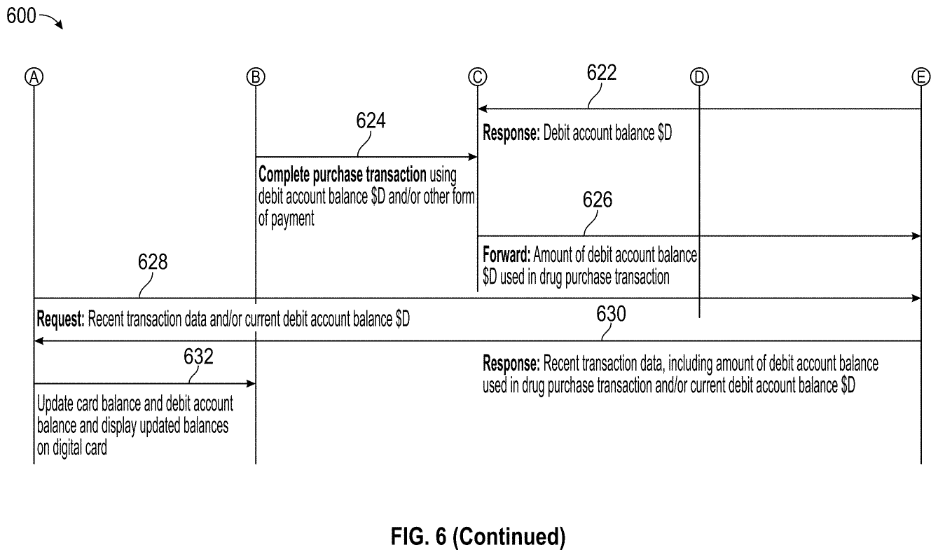

FIG. 6 illustrates an example process 600 for a client (DPD&P cardholder) to complete a drug purchase transaction using the example DPD&P system 300 shown in FIG. 3, using a DPD&P card 325, according to one example embodiment. Unlike method 500 discussed above, in which the client has already redeemed funds onto the DPD&P card prior to initiating the drug purchase transaction, in method 600 shown in FIG. 6 the client interacts with the DPD&P client application 334 to redeem funds onto the DPD&P card during the purchase transaction, which redeemed funds are then used for all or a portion of the drug purchase.

At 602, the client may initiate a drug purchase at a pharmacy POS system 308, e.g., by providing the pharmacist (a) the client's pharmacy discount identification information and (b) an identification of a drug or drugs to be purchased. To provide the pharmacist the client's pharmacy discount identification information, the client may open DPD&P client application 334 at a smartphone or other mobile device 304 and navigate to a page displaying a selected DPD&P card showing the DPD&P card ID information, e.g., any of the “My Wallet” screens shown in FIG. 4H, 4I, or 4J, which displays at mobile device GUI 357 a selected DPD&P card including pharmacy discount card ID information 430, in this example Auth #, BIN, GRP, and PCN numbers. The pharmacist may read the displayed DPD&P card ID information 430 and enter (e.g., via manual keyboard entry) this information, along with the requested drug(s), into a pharmacy POS terminal 366 using any suitable data entry interface.

At 604, the pharmacy POS system 308 (e.g., POS terminal 366 in particular) may forward the information entered at 502 to a relevant PBM 312. At 606, the BMB 312 may determine and return a discounted drug cost ($P) to the pharmacy POS terminal 308, e.g., based on stored pharmacy discount information 380 for particular the Walmart pharmacy and/or drug pricing and discount data 382 corresponding with the client's pharmacy discount identification information.

At 608, the pharmacy POS terminal 308, or the pharmacist viewing terminal 308, may then relay the drug cost ($P) received from PBM 312 to the client. Steps 602-608 discussed above are similar to steps 502-508 of method 500 shown in FIG. 5. After step 608, the method departs from that of method 500. Instead of initiating payment from previously-redeemed funds on the DPD&P card debit account (as in method 500), at step 610 the client may first initiate a funds redemption request to redeem a desired amount of funds (e.g., all or a portion of the current available DPD&P card balance) into debit account linked to the DPD&P card (referred to herein as a DPD&P card debit account). For example, with reference to the DPD&P client application screens 400H and 4001 shown in FIGS. 4H and 4I, the client may select the “Redeem Now” button 425 and then enter or select at input field 435 an amount to be redeemed ($R) from an available card balance ($C), at input field 435. In the example shown in FIG. 4I, the client requests a redemption of $75 ($R=$75) from an available card balance ($C) of $520, which would reduce the card balance to $445. The DPD&P client application 334 forwards the client identification information and redemption request for amount $R ($75) to the DPD&P management application 332 at DPD&P management server 302.

At 612, upon receiving the redemption request from the DPD&P client application 334, the DPD&P management application 332 forwards funds redemption request, including the client identification information and redemption request for amount $R ($75), to a pharmacy-associated bank 310 associated with the relevant pharmacy. In response, at 614, the pharmacy-associated bank 310 identifies and updates the client's DPD&P card account balance information 392 (if the redemption request can be granted), and returns a redemption request response including the DPD&P card debit account number and balance ($D) to DPD&P management application 332 at DPD&P management server 302. In some embodiments or instances, the pharmacy-associated bank 310 may generate a new DPD&P card debit account, and manage the corresponding balance, for each redemption request from a client. In such embodiments or instances, the redemption request response may identify the new DPD&P card debit account number and balance ($D=$R). In other embodiments or instances, the pharmacy-associated bank 310 may update (increase) the balance of an existing debit account linked to the DPD&P card by the redeemed amount ($R). In such embodiments or instances, the redemption request response may identify the existing DPD&P card debit account number and the updated balance ($D=previous debit account balance+$R).

At 616, DPD&P client application 334 may access (e.g., from DPD&P management application 332) and display at the mobile device GUI 357: the DPD&P card debit account number (e.g., in the form of a displayed number 450 or barcode 460 representing the debit account number), the DPD&P card debit account balance ($D), and the updated (i.e., reduced by $R) DPD&P card balance ($C).

To make payment of the drug cost ($P) determined by PBM 312, at 618 the pharmacist may enter the DPD&P card debit account number 450 or barcode 460 into the POS terminal 366, e.g., by typing in the debit account number 450 or scanning the barcode 460 using a bar code scanner 368. At 620, the POS terminal 366 may then forward the DPD&P card debit account number to a pharmacy-associated bank 310. At 622, the bank 310 may then identify the relevant account balance ($D) corresponding with the DPD&P card debit account number, and communicate the account balance ($D) to the POS terminal 366, or at least an indication of whether the account balance ($D) is sufficient to cover the cost of the drugs ($P). In some embodiments or instances, the POS terminal 366 may display the account balance ($D) to the client, or the pharmacist may relay such information displayed at the POS terminal 366 to the client.

At 624, the client may then interact with the pharmacist and pharmacist POS terminal 36 to compete the purchase transaction using some or all of the DPD&P card debit account balance ($D) and/or another form of payment (e.g., credit card, debit card, cash, check, etc.). For example, the client may then determine and indicate to the pharmacist the amount (if any) of the DPD&P card debit account balance ($D) to apply to the drug purchase, and the pharmacist may enter such value at the POS terminal 366. If the elected (or available) DPD&P card debit account balance ($D) is less than the total cost of the drugs ($P), the client may pay the remainder ($P-$D) using any other form of payment, e.g., using a credit/debit card reader 370 at the pharmacy POS system 308.

At 626, the amount of the DPD&P card debit account balance applied to the drug purchase, as entered into the POS terminal 366 at 624, is forwarded to the pharmacy-associated bank 310, which may then update the DPD&P card account balance information 392 accordingly.

The pharmacy-associated bank 310 may then (or at some later time) notify DPD&P management application 332 at the relevant DPD&P management server 302 of the drug purchase transaction and the updated DPD&P card account balance information 392, such that DPD&P management application 332 at may update the records in DPD&P management server memory 324. In the embodiment shown in FIG. 5, at 628, DPD&P management application 332 may periodically request, e.g., at a specified frequency or in response to a defined triggering event, recent transaction data and DPD&P card account balance updates from the pharmacy-associated bank 310. Server 302 may request data regarding the particular DPD&P card debit account, or data regarding all DPD&P card debit accounts managed by bank 310. At 630, bank 310 may access and forward the requested information to DPD&P management application 332 at DPD&P management server 302. In an alternative embodiment, rather than awaiting update requests from DPD&P management application 332 (step 628), the pharmacy-associated bank 310 may automatically send DPD&P management application 332 the transaction data and updated DPD&P card account balance information upon completion of each purchase transaction involving bank 310.

At 632, DPD&P management application 332 may update the records in DPD&P management server memory 324, e.g., DPD&P card debit account balance information 328 and transaction history data 330, based on the information received from bank 310, and DPD&P client application may then access display at the mobile device GUI 357 the updated DPD&P card debit account balance.

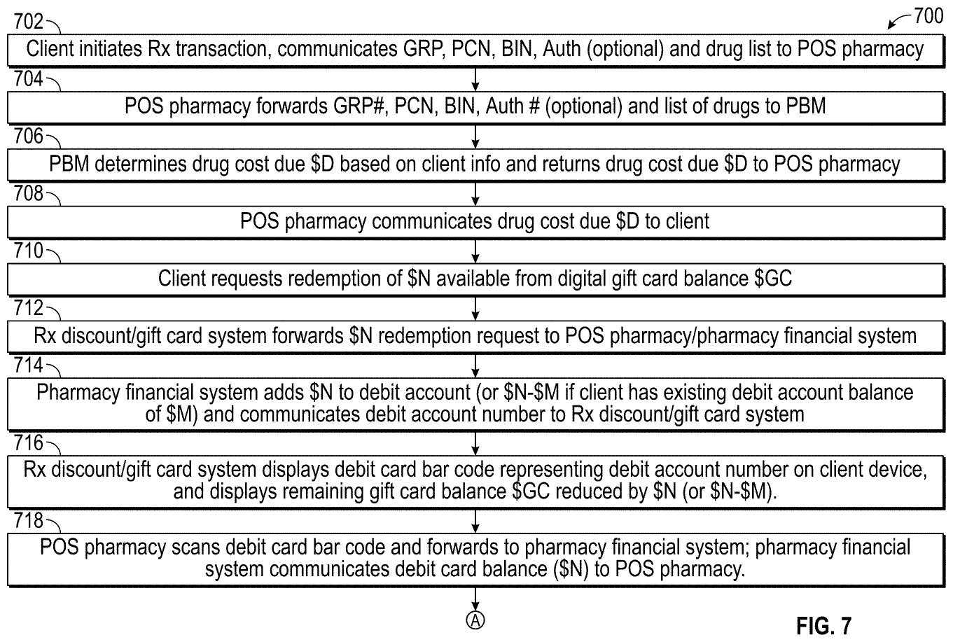

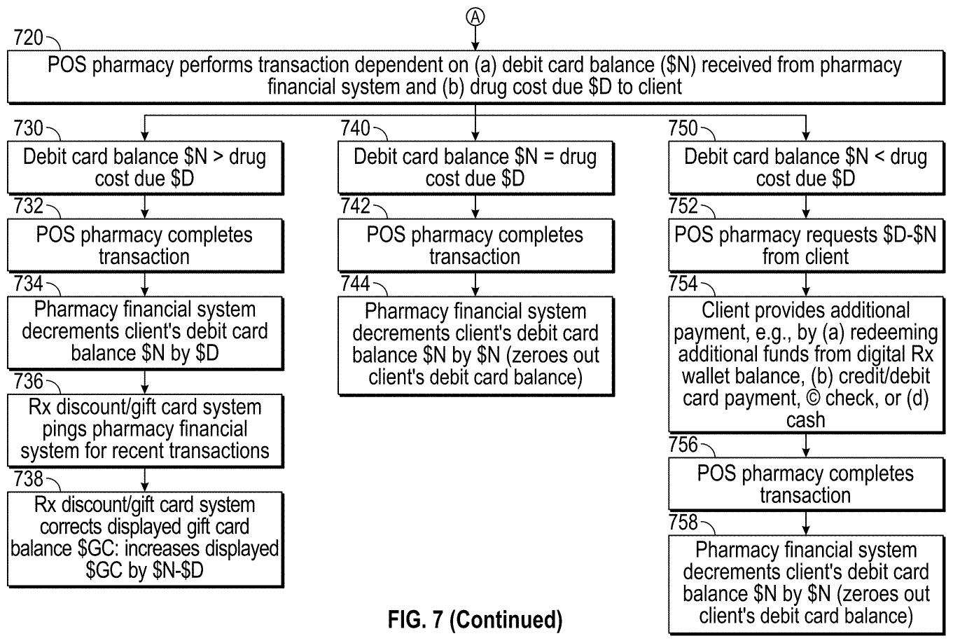

FIG. 7 is a flowchart 700 providing an another representation of the example process 600 shown in FIG. 6, according to one example embodiment.

Although the disclosed embodiments are described in detail in the present disclosure, it should be understood that various changes, substitutions and alterations can be made to the embodiments without departing from their spirit and scope.

1. A system for managing a digital card usable by a client for receiving discounts on drugs purchased from a pharmacy and also usable for payment of drug purchases, the system comprising:
non-transitory computer-readable media storing computer instructions for managing and using the digital card; and
at least one processor configured to execute the computer instructions to:
display, at a client mobile device, a representation of the digital card, including prescription drug discount identification information associated with the digital card, the prescription drug discount identification usable for receiving discounts on drugs purchased from the pharmacy;
display, at a client mobile device, a card balance associated with the digital card;
receive, at the client mobile device, a funds redemption request to redeem a first amount representing at least a portion of the card balance;
forward the funds redemption request to a financial entity for generating or updating a debit account balance linked to the digital card as a function of the first amount; and
during a drug purchase transaction for at least one drug, display at the client mobile device a debit account identifier linked to the debit account balance, the debit account identifier being readable at a pharmacy point-of-sale system for accessing the debit account balance to make a full or partial payment for the at least one drug.

2. The system of claim 1, wherein the at least one processor is further configured to, during the drug purchase transaction for at least one drug:
send a discount request to a pharmacy benefits manager computer system, the discount request including (a) the prescription drug discount identification information associated with the digital card and (b) an identification of the at least one drug; and
receive a discount request response from the pharmacy benefits manager computer system, the discount request response identifying a discounted price for the at least one drug determined based at least on the forwarded prescription drug discount identification information.

3. The system of claim 2, wherein the funds redemption request is received at the client mobile device and forwarded to the financial entity after the discount request discount request response is received from the pharmacy benefits manager computer system.

4. The system of claim 1, wherein the at least one processor is further configured to receive and forward the funds redemption request to the financial entity for generating or updating the debit account balance during the drug purchase transaction.

5. The system of claim 1, wherein receiving the funds redemption request at the client mobile device comprises receiving input from the client, at the client mobile device, indicating the first amount to be redeemed.

6. The system of claim 1, wherein the at least one processor is further configured to display at the client mobile device, after the drug purchase, an updated card balance for the digital card, the updated card balance being updated based on the full or partial payment for the at least one drug made using the debit account balance.

7. The system of claim 1, wherein the at least one processor is further configured to receive from the financial entity, in response to the forwarded funds redemption request, the debit account identifier or a corresponding debit account number linked to the debit account balance.

8. The system of claim 1, wherein displaying the debit account identifier at the client mobile device comprises displaying a barcode or other scannable representation of a debit account identification number.

9. A method for using a digital card usable by a client for receiving discounts on drugs purchased from a pharmacy and also usable for payment of drug purchases, the method comprising:
displaying, at a client mobile device, a representation of the digital card, including prescription drug discount identification information associated with the digital card, the prescription drug discount identification usable for receiving discounts on drugs purchased from the pharmacy;
displaying, at a client mobile device, a card balance associated with the digital card;
receiving, at the client mobile device, a funds redemption request to redeem a first amount representing at least a portion of the card balance;
forwarding the funds redemption request to a financial entity for generating or updating a debit account balance linked to the digital card as a function of the first amount; and
during a drug purchase transaction for at least one drug, displaying at the client mobile device a debit account identifier linked to the debit account balance, the debit account identifier being readable at a pharmacy point-of-sale system for accessing the debit account balance to make a full or partial payment for the at least one drug.

10. The method of claim 9, further comprising:
during the drug purchase transaction for at least one drug:
sending a discount request to a pharmacy benefits manager computer system, the discount request including (a) the prescription drug discount identification information associated with the digital card and (b) an identification of the at least one drug; and
receiving a discount request response from the pharmacy benefits manager computer system, the discount request response identifying a discounted price for the at least one drug determined based at least on the forwarded prescription drug discount identification information.

11. The method of claim 10, wherein the steps of sending the discount request and receiving the discount request response are performed by a pharmacy point-of-sale processor.

12. The method of claim 10, wherein the steps of receiving and forwarding the funds redemption request are performed after the discount request response is received from the pharmacy benefits manager computer system.

13. The method of claim 9, wherein the steps of receiving and forwarding the funds redemption request to the financial entity for generating or updating the debit account balance are performed prior to the drug purchase transaction.

14. The method of claim 9, wherein the steps of receiving and forwarding the funds redemption request to the financial entity for generating or updating the debit account balance are performed during the drug purchase transaction.

15. The method of claim 9, wherein receiving the funds redemption request at the client mobile device comprises receiving input from the client, at the client mobile device, indicating the first amount to be redeemed.

16. The method of claim 9, further comprising, after the drug purchase, displaying at the client mobile device an updated card balance for the digital card, the updated card balance being updated based on the full or partial payment for the at least one drug made using the debit account balance.

17. The method of claim 9, further comprising receiving from the financial entity, in response to the forwarded funds redemption request, the debit account identifier or a corresponding debit account number linked to the debit account balance.

18. The method of claim 9, wherein displaying the debit account identifier at the client mobile device comprises displaying a barcode or other scannable representation of a debit account identification number.

19. A system for processing a prescription drug purchase by a client using a digital card displayable on a client mobile device, the digital card including (a) prescription drug discount identification information for receiving discounts on prescription drugs and (b) an account balance associated with the digital card, the system comprising:
non-transitory computer-readable media storing computer instructions for processing a prescription drug purchase using the displayable digital card; and
at least one processor associated with a pharmacy point-of-sale (POS) system and configured to execute the computer instructions to:
during a drug purchase transaction for at least one drug, collect the prescription drug discount identification information associated with the digital card and displayed on the client mobile device;
send, to a computer system of a pharmacy benefits manager, a discount request including (a) the collected prescription drug discount identification information associated with the digital card and (b) an identification of the at least one drug receive, from the computer system of the pharmacy benefits manager, a discount request response identifying a discounted drug price for the at least one drug;
collect account identification information read from the client mobile device;
send, to a computer system of a financial system, the collected account identification information;
receive, from the computer system of the financial system, a debit account balance associated with the collected account identification information; and
complete the transaction to purchase the particular drugs by the client, based at least on account balance received from the financial system.

20. The system of claim 11, wherein collecting account identification information read from the client mobile device comprises scanning a bar code or other scannable account identifier displayed on the client mobile device.
